(19) United States
(12) Patent Application Publication
(10) Pub. No.: US 2003/0172225 A1
(43) Pub. Date: Sep. 11, 2003

(54) Single port ram presented as multiport RAM

(76) Inventor: Andrew Carl Brown, Colorado Springs, CO (US)

Correspondence Address: LSI Logic Corporation, Corporate Legal Department, Intellectual Property Services Group, 1551 McCarthy Boulevard, M/S D-106, Milpitas, CA, 95035, US

(21) Appl. No.: 10/093,664

(22) Filed: Mar. 8, 2002

(51) Int. Cl. G06F 12/00

(52) U.S. Cl. 711/104; 711/149; 711/151

(57) ABSTRACT

A virtual multiple port memory device and method are disclosed. The virtual multiple port memory device includes a random access memory having only one access port, multiple bus connection ports, and an arbiter for selectively granting to one of the bus connection ports access to the only access port. Each one of multiple processors or agents is coupled to a different one of the bus connection ports in the virtual multiple port memory device utilizing its own, dedicated bus.

### BACKGROUND OF THE INVENTION

1. Technical Field

The present invention is directed generally toward a method and device for a single port RAM capable of being utilized as a multiport RAM.

2. Description of the Related Art

Memory devices, such as random access memories (RAMs), are known in the art. Some memory devices are single port devices, such as depicted by FIG. 5, and some are multiport devices, such as depicted by FIG. 7. Referring to FIG. 5, a single port RAM 500 includes only one access port 502. A device, such as processor 504, may be coupled to port 502 utilizing a dedicated bus 506. Multiple processors cannot be simultaneously coupled to a single port RAM where each processor includes its own, dedicated bus.

Multiple processors may be simultaneously coupled to a single port RAM utilizing a bus bridge as depicted in FIG. 6. Single port RAM 600 includes a single access port 602. A bus bridge 604 may be coupled to port 602 utilizing a bus 606. When bus bridge 604 is used, processors 608 and 610 are coupled to bus bridge 604 utilizing a shared bus 612. The processors must share a bus in order to access single port RAM 600.

In order for multiple processors to be simultaneously coupled to a memory device where each processor has its own, dedicated bus, a multiport device has been used in the prior art. A multiport RAM includes multiple, separate access ports for reading from and writing to the RAM. FIG. 7 is a high level example of a multiport RAM 700. Processors 702, 704, and 706 are simultaneously coupled to multiport RAM 700 through separate access ports utilizing buses dedicated to each processor. Processor 702 is coupled to port 708 utilizing a dedicated bus 710. Processor 704 is coupled to port 712 utilizing a dedicated bus 714. And, processor 706 is coupled to port 716 utilizing a dedicated bus 718.

Multiport devices, such as depicted in FIG. 7, are physically extremely large. When the storage size of a required memory device is large, a multiport device becomes impractical to implement. Mutliport devices do, however, offer advantages when multiple processors need to share a RAM. For example, although the implementation of FIG. 6 allows multiple processors to share the same single port RAM, the implementation is very inefficient. Processors 608 and 610 are put at a severe latency disadvantage.

Therefore, a need exists for a virtual multiport memory device whereby a single port memory device is presented as a multiport device.

### SUMMARY OF THE INVENTION

A virtual multiple port memory device and method are disclosed. The virtual multiple port memory device includes a random access memory having only one access port, multiple bus connection ports, and an arbiter for selectively granting to one of the bus connection ports access to the only access port. Each one of multiple processors or agents is coupled to a different one of the bus connection ports in the virtual multiple port memory device utilizing its own, dedicated bus. The arbiter grants access to the single port RAM based on a priority assigned to each processor. Thus, the single port RAM appears to the processors to be a multiport RAM.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram of a virtual multiport memory device in accordance with the present invention;

FIG. 2 depicts a high level flow chart which illustrates a processor requesting access to a virtual multiport memory device in accordance with the present invention;

FIG. 3 illustrates a high level flow chart which depicts a bus communication port requesting access to a single port memory device in accordance with the present invention;

FIG. 4 depicts a high level flow chart which illustrates an arbiter, which is included in a virtual multiport memory device, processing requests in accordance with the present invention;

FIG. 5 is a block diagram of a single port RAM coupled to a single processor in accordance with the prior art;

FIG. 6 is a block diagram of a single port RAM coupled to multiple processors using a bus bridge in accordance with the prior art;

FIG. 7 is a block diagram of a multiport RAM coupled to multiple processors in accordance with the prior art; and

FIGS. 8A-8G together depict programming code that may be utilized to implement the present invention.

### DETAILED DESCRIPTION

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated.

The present invention is a single port memory device that is utilized as a multiple-port memory device. The device includes a plurality of bus connection ports. Each bus connection port can be coupled to a device, such as a processor or agent, utilizing a dedicated bus. Thus, each one of a plurality of processors can be coupled directly to the memory device utilizing its own dedicated bus. Each one of the processors receives dedicated access to the single port memory device. An arbiter is included in the memory device. The arbiter receives from the bus connection ports requests to access the single port memory device. The arbiter then selectively grants to the bus connection ports access to the single port memory device. The processors, through their bus connection ports, are granted access to the RAM one at a time based on their assigned priority.

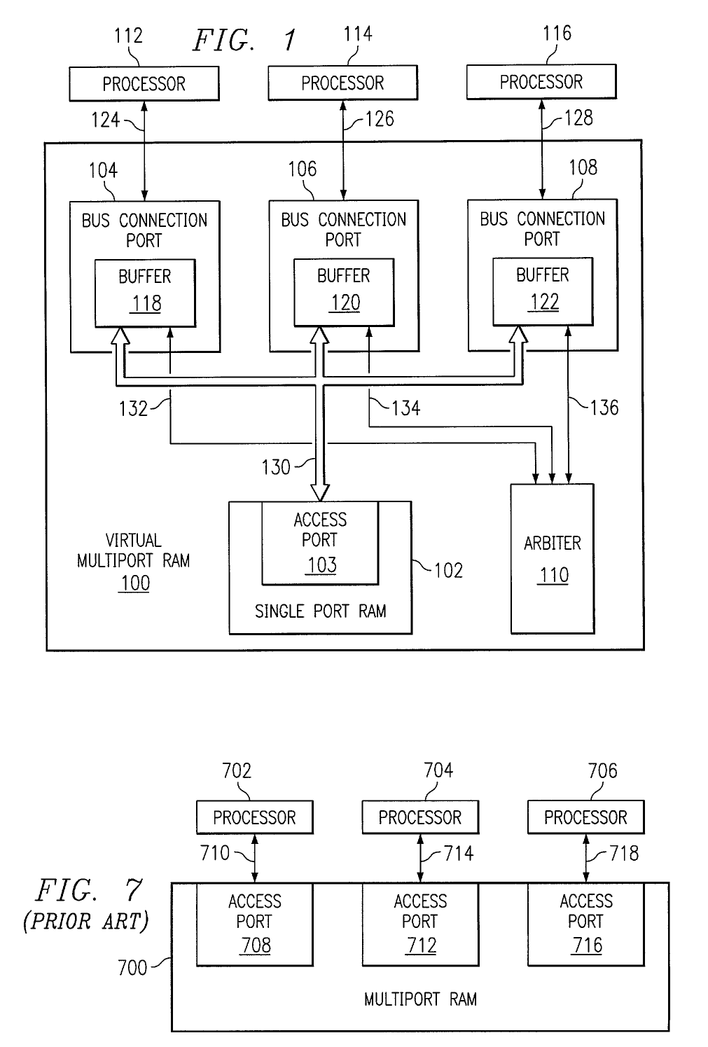

FIG. 1 is a block diagram of a virtual multiport memory device in accordance with the present invention. A virtual multiport memory device 100 includes a single port memory device 102, a bus connection port 104, a bus connection port 106, a bus connection port 108, and an arbiter 110. Single port memory device 102 includes only one access port 103 for reading from and writing to device 102. A separate processor is coupled to each bus connection port. Processor 112 is coupled to port 104. Processor 114 is coupled to port 106. And, processor 116 is coupled to port 108. Each port includes a write buffer. Port 104 includes write buffer 118. Port 106 includes write buffer 120. And, port 108 includes write buffer 122.

Each processor is coupled to memory device 100 utilizing its own, dedicated bus. Processor 112 is coupled to port 104 utilizing bus 124. Processor 114 is coupled to port 106 utilizing bus 126. And, processor 116 is coupled to port 108 utilizing bus 128. Single port RAM 102 is coupled to ports 104, 106, and 108 utilizing a shared backend bus 130.

Arbiter 110 communicates with bus connection ports by receiving requests for access and transmitting grants to the bus connection ports utilizing request lines. Arbiter 110 communicates with port 104 utilizing request line 132. Arbiter 110 communicates with port 106 utilizing request line 134. And, arbiter 110 communicates with port 108 utilizing request line 136.

The processors transmit requests to the bus connection port to which they are coupled utilizing their dedicated buses. The requests transmitted by the processors are requests to read data from or write data to single port RAM 102. These requests include the priority assigned to the processor that transmitted the request. Once a bus connection port receives such a request from its processor, the bus connection port transmits an access request to arbiter 110 utilizing one of the request lines 132, 134, or 136. When arbiter 110 has determined to grant access to a particular bus connection port, arbiter 110 transmits a grant to the bus connection port utilizing the request line coupling arbiter 110 to that bus connection port. The bus connection port then accesses single port RAM utilizing the backend bus shared by all of the bus connection ports by transmitting the request the bus connection port received from its processor.

Arbiter 110 determines whether or not to grant an access request. Arbiter 110 will grant access to RAM 102 when no bus connection port is currently accessing single port RAM 102 and no other requests have been received. When two or more requests are pending, arbiter 110 grants access to the bus connection port that transmitted a request having the highest priority. Once access is granted to RAM 102, the processor, through its bus connection port, has access to RAM 102 until its request has been serviced. Arbiter 110 routinely checks the request lines to determine whether any requests have been received. Once a processor's request has been serviced, arbiter 110 will evaluate the request lines and then grant access to the pending request from the processor having the highest priority.

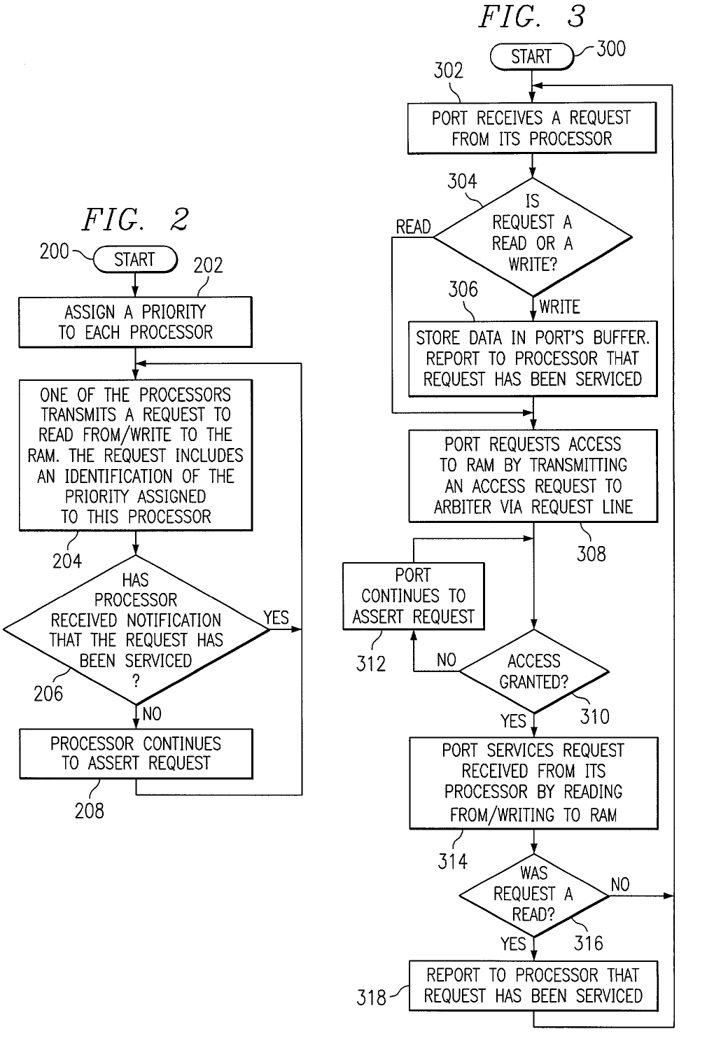

FIG. 2 depicts a high level flow chart which illustrates a processor requesting access to a virtual multiport memory device in accordance with the present invention. The process starts as depicted by block 200 and thereafter passes to block 202 which illustrates assigning a priority to each processor that is coupled to the multiport memory device. Next, block 204 depicts one of the processors transmitting a request to read data from or write data to the multiport memory device. This request includes an identification of the priority assigned to this processor.

The process then passes to block 206 which illustrates a determination of whether or not the processor has received a notification that the request has been serviced. If a determination is made that the processor has received a notification that the request has been serviced, the process passes back to block 204. Referring again to block 206, if a determination is made that the processor has not received a notification that the request has been serviced, the process passes to block 208 which depicts the processor continuing to assert its request. Thus, a processor will continue to assert its request until that request has been serviced. While a processor is asserting its request, the processor will be held in wait states. The process then passes back to block 204.

FIG. 3 illustrates a high level flow chart which depicts a bus communication port requesting access to a single port memory device 102 in accordance with the present invention. The process starts as depicted by block 300 and thereafter passes to block 302 which illustrates a bus communication port receiving a request from a processor to access a single port memory device 102. Next, block 304 depicts a determination of whether or not this request is a read or a write request. If a determination is made that this is a read request, the process passes to block 308. Referring again to block 304, if a determination is made that this is a write request, the process passes to block 306 which illustrates storing within the bus communication port's write buffer, such as write buffer 118, 120, or 122, the data to be written to the memory device 102. The bus communication port then reports to the processor that the request has been serviced.

The process then passes to block 308 which depicts the bus communication port transmitting an access request to the arbiter requesting access to the single port memory device 102. The bus connection port includes the priority in its access request that was received in the request from its processor. Thus, the priority assigned to this processor is passed from the bus connection port to the arbiter in the bus connection port's access request. Next, block 310 illustrates a determination of whether or not access has been granted to the bus communication port. If a determination is made that access has not been granted to the bus communication port, the process passes to block 312 which depicts the port continuing to assert its request. The process then passes back to block 310.

Referring again to block 310, if a determination is made that access has not been granted to the port, the process passes to block 314 which illustrates the port servicing the request received from its processor by reading from or writing to the memory device 102. Thereafter, block 316 depicts a determination of whether or not the request was a read request. If a determination is made that the request was a read request, the process passes to block 318 which illustrates the bus communication port reporting to the processor that the request has been serviced. The process then passes to block 302. Referring again to block 316, if a determination is made that the request was not a read request, i.e. it was a write request, the process passes to block 302.

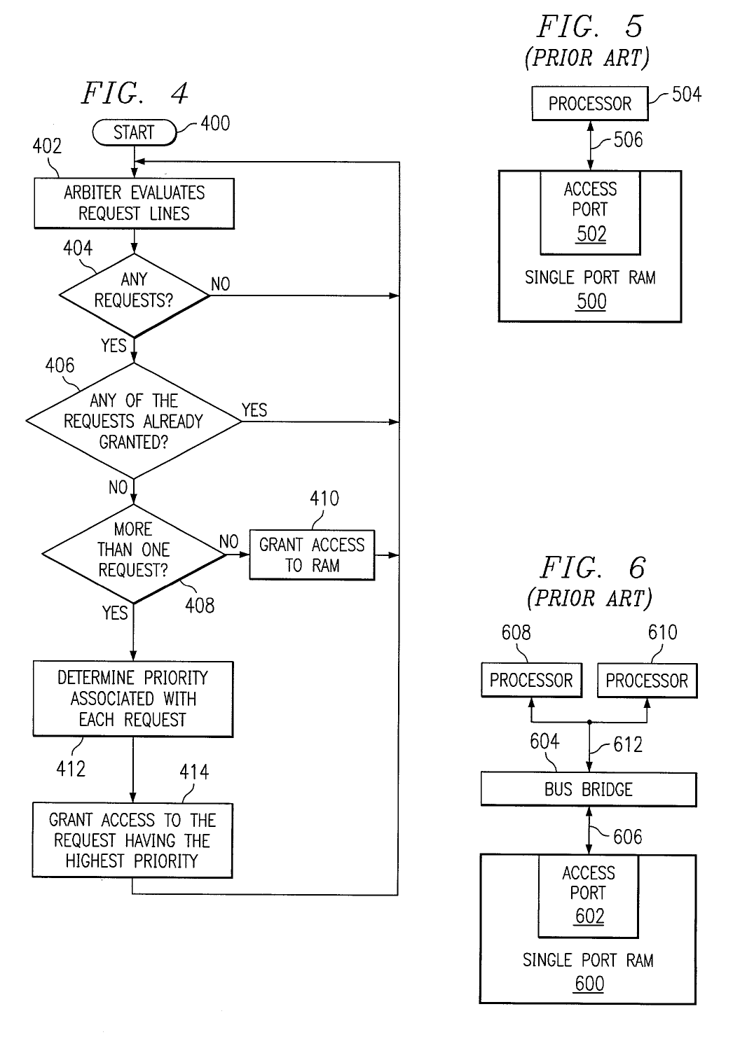

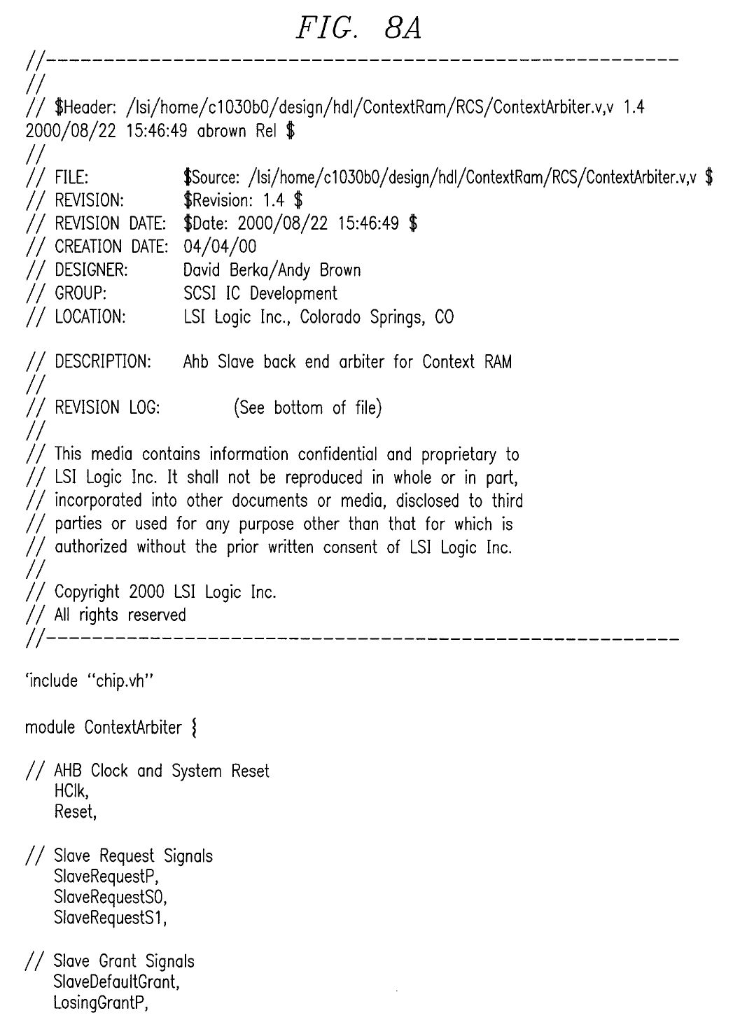

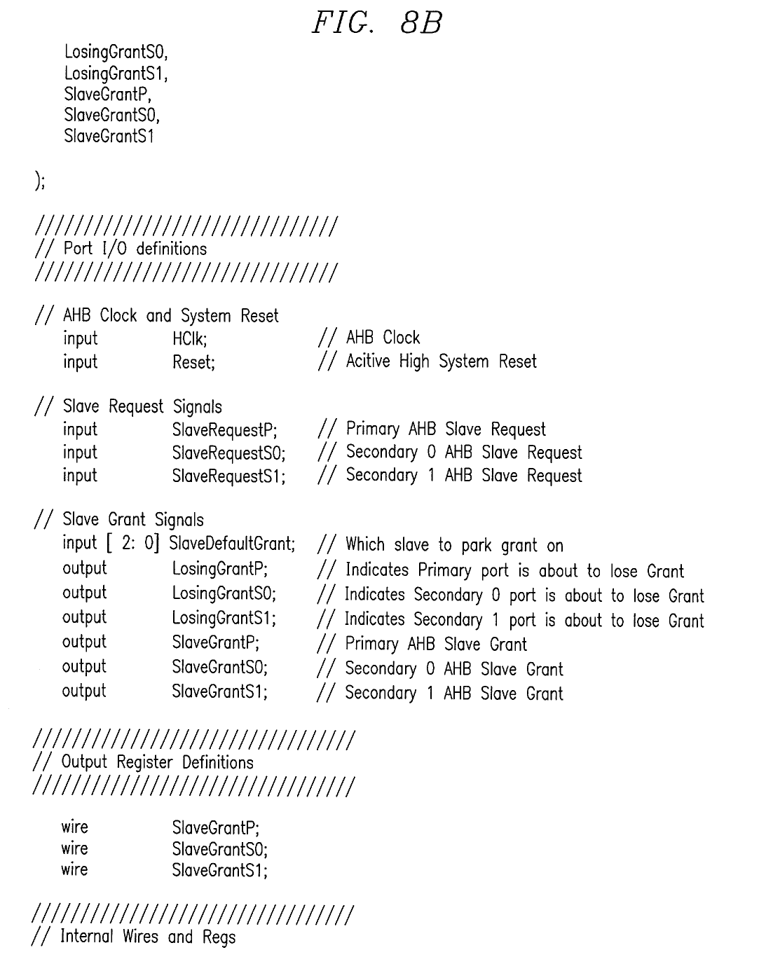

FIG. 4 depicts a high level flow chart which illustrates an arbiter, which is included in a virtual multiport memory device, processing requests in accordance with the present invention. The process starts as depicted by block 400 and thereafter passes to block 402 which illustrates the arbiter evaluating its request lines. Next, block 404 depicts a determination of whether or not the arbiter has received any access requests from bus connection ports. If a determination is made that the arbiter has not received any access requests, the process passes to block 402.

Referring again to block 404, if a determination is made that the arbiter has received at least one access request, the process passes to block 406 which illustrates a determination of whether or not any of the bus connection ports that transmitted the access requests received by the arbiter have already been granted access to the single port memory device 102. If a determination is made that one of the bus connection ports that transmitted an access requests received by the arbiter has already been granted, the process passes back to block 402. Referring again to block 406, if a determination is made that none of the bus connection ports that transmitted access requests received by the arbiter has already been granted, the process passes to block 408.

Block 408 depicts a determination of whether or not the arbiter has received more than one access request. If a determination is made that only one access request has been received, the process passes to block 410 which illustrates the arbiter granting access to the memory device 102 to the port communication port that transmitted this access request. The process then passes to block 402.

Referring again to block 408, if a determination is made that the arbiter received more than one access request, the process passes to block 412 which depicts a determination of the priority included in the processor's request that caused the bus connection port to transmit an access request. Next, block 414 illustrates the arbiter granting access to the bus connection port that transmitted the access request that included the highest priority. The process then passes to block 402.

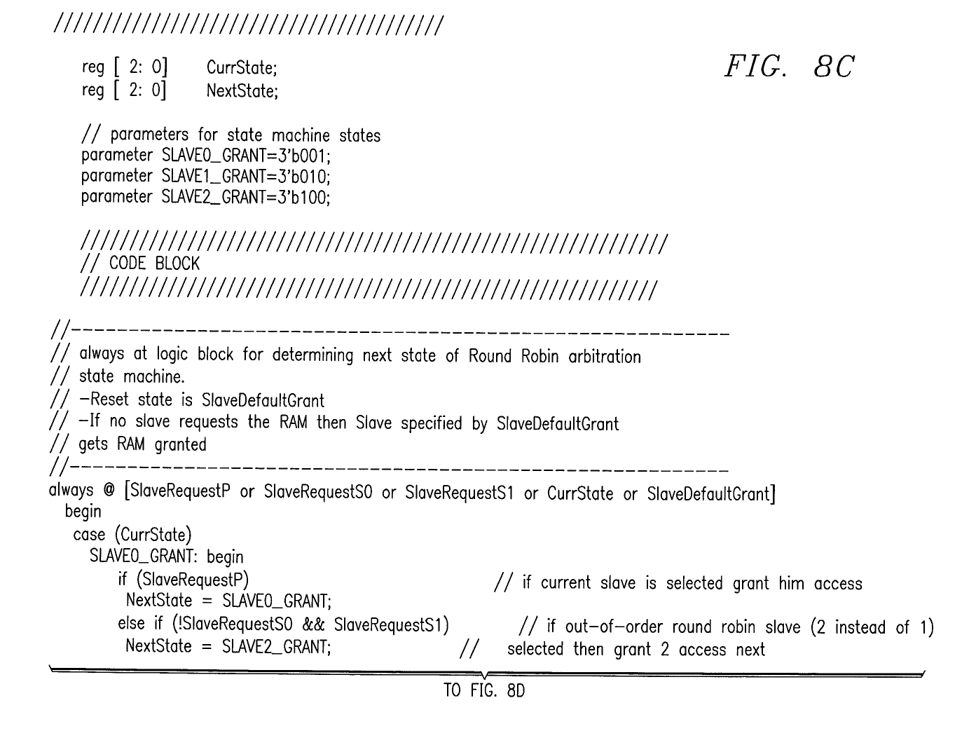

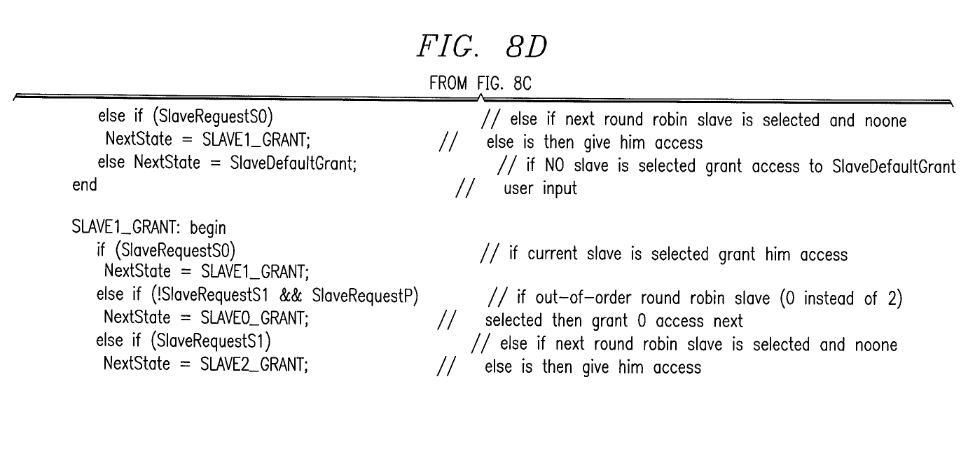

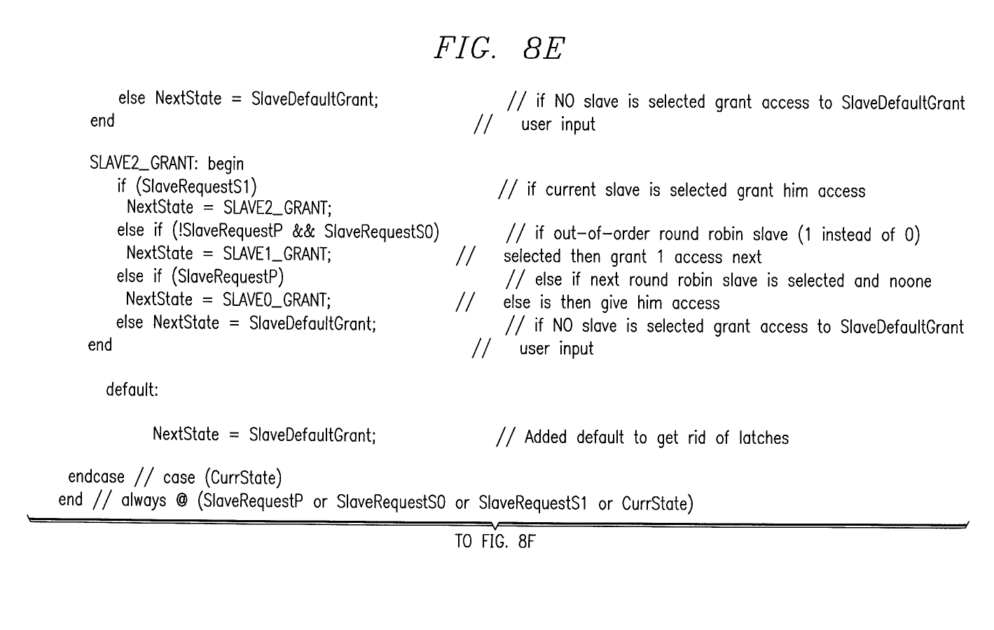

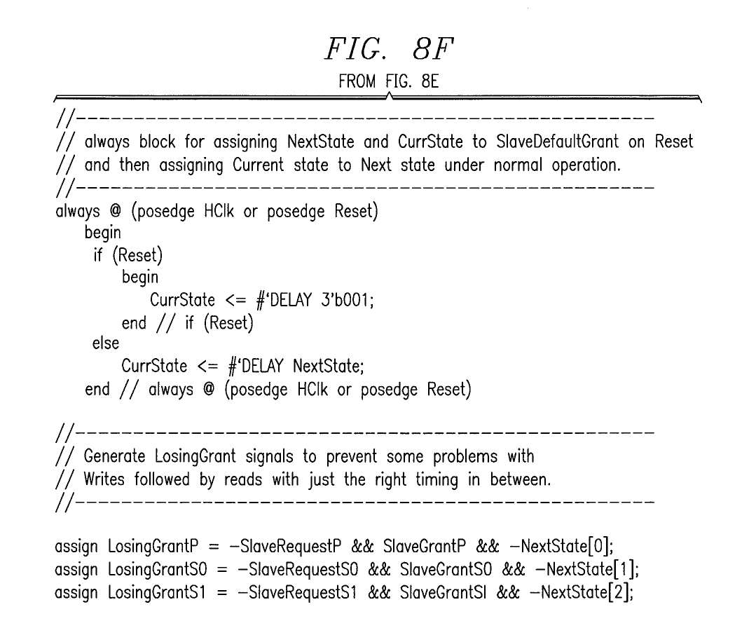

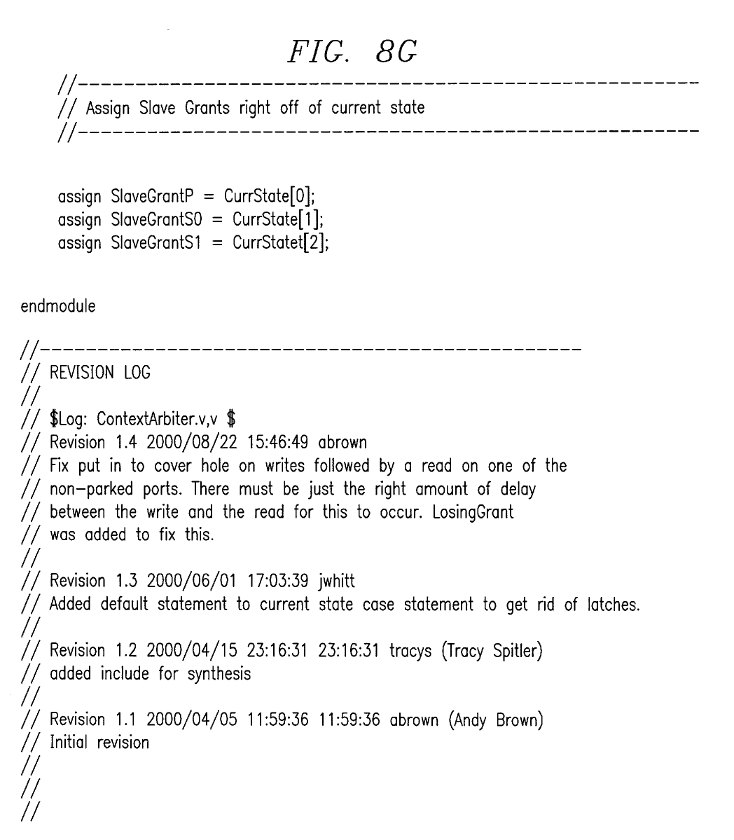

FIGS. 8A-8G together depict programming code that may be utilized to implement the present invention.

What is claimed is:

1. A virtual multiple port memory device comprising:
a random access memory having only one access port;
a plurality of bus connection ports; and
an arbiter for selectively granting to one of said plurality of bus connection ports access to said only one access port.

2. The device according to claim 1, wherein each one of said plurality of bus connection ports is coupled to one of a plurality of different processors utilizing a dedicated bus.

3. The device according to claim 1, further comprising said arbiter including a plurality of request lines, each one of said plurality of request lines being coupled to a different one of said plurality of bus connection ports.

4. The device according to claim 1, further comprising
means for receiving within one of said plurality of bus connection ports a request to access said single port RAM;
said arbiter for determining whether to grant access to said RAM to said one of said plurality of bus connection ports; and
in response to a determination to grant access to said RAM, said one of said plurality of bus connection ports being permitted to access said RAM.

5. The device according to claim 1, further comprising:
each one of a plurality of processors being coupled to a different one of said plurality of bus connection ports utilizing a dedicated bus;
means for assigning a different priority to each one of said plurality of processors; and
means for including said priority in requests transmitted by each one of said plurality of processors.

6. The device according to claim 5, further comprising:
ones of said plurality of bus connection ports for receiving requests at approximately the same time to access said single port RAM;
said arbiter for determining a priority included in each of said requests;
said arbiter for identifying one of said requests having a highest priority; and said arbiter for granting access to one of said plurality of bus connection ports transmitting said one of said requests having said highest priority.

7. The device according to claim 1, further comprising:
said arbiter including a plurality of request lines, each one of said plurality of request lines being coupled to a different one of said plurality of bus connection ports; and
one of said plurality of bus connection ports for receiving a request to access said RAM;
said one of said plurality of bus connection ports for transmitting an access request to said arbiter utilizing one of said plurality of request lines coupled to said one of said plurality of bus connection ports;
said arbiter for transmitting a grant, utilizing said one of said plurality of request lines, to said one of said plurality of bus connection ports in response to said arbiter granting access to said one of said plurality of bus connection ports access to said RAM.

8. A method in a data processing system for utilizing a single port random access memory (RAM) as a multiport random access memory (RAM), said method comprising:
providing a RAM having only one access port;
coupling said only one access port to a plurality of bus connection ports utilizing a bus; and
providing an arbiter for selecting one of said plurality of bus connection ports to which to grant access to said only one access port.

9. The method according to claim 8, further comprising the step of coupling each one of a plurality of processors to a different one of said plurality of bus connection ports utilizing a dedicated bus.

10. The method according to claim 8, further comprising the steps of:
receiving within one of said plurality of bus connection ports a request to access said single port RAM;
determining, utilizing said arbiter, whether to grant access to said RAM;
in response to a determination to grant access to said RAM, accessing, by said one of said plurality of bus connection ports, said RAM.

11. The method according to claim 8, further comprising the steps of:
coupling each one of a plurality of processors to a different one of said plurality of bus connection ports utilizing a dedicated bus;
assigning a different priority to each one of said plurality of processors; and
including said priority in requests transmitted by each one of said plurality of processors.

12. The method according to claim 11, further comprising the steps of:
receiving, at approximately the same time, requests within ones of said plurality of bus connection ports to access said single port RAM;
determining a priority included in each of said requests;
identifying one of said requests having a highest priority; and
granting access to one of said plurality of bus connection ports transmitting said one of said requests having said highest priority.

13. A virtual multiple port memory device comprising:
a random access memory having only one access port;
a plurality of processors;
a plurality of bus connection ports;
each one of said plurality of processors being coupled to a different one of said plurality of bus connection ports utilizing its own, dedicated bus; and
an arbiter for selectively granting to one of said plurality of bus connection ports access to said only one access port.
